(19) United States
(12) Patent Application Publication
(10) Pub. No.: US 2007/0058821 A1
(43) Pub. Date: Mar. 15, 2007

(54) Automotive microphone assembly

(75) Inventors: Christopher Todd Welsh, Fishers, IN (US); Jeffrey Phillip McAteer, Indianapolis, IN (US)

Correspondence Address: Doreen J. Gridley;ICE MILLER, One American Square, Box 82001, Indianapolis, IN, 46282-0200, US

(73) Assignee: MWM Acoustics, LLC, (an Indiana limited liability company), Indianapolis, IN (US)

(21) Appl. No.: 11/226,124

(22) Filed: Sep. 12, 2005

(51) Int. Cl. H04R 1/02

(52) U.S. Cl. 381/91

(57) ABSTRACT

An automotive microphone assembly. According to one embodiment of the present invention, the assembly comprises a first microphone, a second microphone, a connection means, and a housing. The connection means provides for electrical connection to the first and second microphones, and for connection to a first automotive subsystem and a second automotive subsystem, respectively. The first subsystem and second subsystem may comprise a telephony subsystem, speech recognition subsystem, speech recording subsystem, intercom subsystem, noise control subsystem, noise compensation subsystem, or noise monitoring subsystem. By use of the assembly of the present invention, a single microphone assembly may be used in support of multiple automotive subsystems, thereby saving space in the automobile and realizing costs savings in having a single assembly. In addition, the assembly is comprised of reasonably priced components, is easy to assemble, and permits for repair or replacement of the assembly or components thereof.

### BACKGROUND OF THE INVENTION

The present invention relates to microphones, and, more particularly, to an automotive microphone assembly.

Today's automobiles are becoming more complex in a variety of ways. One of those ways is in the accommodation of electronic devices used by the driver. Some vehicles include the ability to connect to cellular phones, the ability to connect to computer networks, complex sound systems, and/or entertainment systems, for example. Another way that vehicles have become more complex involves the use of “convenience” technologies. For example, some vehicles have navigation systems and/or a voice recognition system such as may be used to command features of the vehicle, including but not limited to the sound system, as well as a speech recording system or an intercom system.

Yet another way in which vehicles have become complex involves electronic control of previously uncontrolled operations of the vehicle. Vehicle stability systems, traction control, hybrid engines, noise monitoring or compression, noise control, and control of the engine's valves are a few examples of such electronic controls. For example, to conserve the consumption of fuel, some manufacturers reduce the number of valves used to run the vehicle at somewhat constant highway speeds. Such reduction in the number of valves used does, however, result in additional engine noise. Thus, in addition to the electronics required to control the number of valves, an electronic system is used to reduce the noise level in the cabin of the vehicle when the number of valves used is reduced.

Because there has been a significant increase in the use of electronics in vehicles, there is concern with respect to the costs associated with such electronics. In addition, there are usually limitations as to the location and size of components added to a vehicle. Thus, it is desired to provide an electronic assembly that reduces the cost of the electronics and reduces the physical space required for the vehicle's electronics.

More than one of the types of electronic systems found in vehicles require the use of a microphone to pickup (detect) certain sounds. These systems include, but not are not limited to, telephony systems, voice recognition systems, speech recording systems, intercom systems, noise control systems, noise compression systems, and noise monitoring systems. Thus, it is desired to provide a microphone assembly that serves multiple systems in an automotive application, and, in particular, an assembly that serves both: (a) a telephony system, a voice communication system, a speech recording system, or an intercom system, and (b) the active noise control, noise compression, or noise monitoring system of an automobile. It is also desired that such an assembly be made of reasonably priced components, be easy to assemble, and permit for maintenance and repair of the components of the assembly.

### BRIEF DESCRIPTION OF THE DRAWINGS

FIG. 1 shows a perspective view of one embodiment of an automotive microphone assembly of the present invention.

FIG. 2 shows a perspective view of the embodiment of FIG. 1 with the components of the automotive microphone assembly separated to illustrate assembly of the components.

FIG. 3 shows a cross-sectional view of the embodiment of the automotive microphone assembly of FIG. 1 along line A-A of FIG. 1.

FIG. 4 shows a schematic diagram of one embodiment of the printed circuit board of the automotive microphone assembly of the present invention.

FIG. 5 shows an assembly diagram of the embodiment of the printed circuit board of the automotive microphone assembly of FIG. 4.

### SUMMARY OF THE INVENTION

The present invention comprises an microphone assembly. The invention accommodates more than one microphone system for support of multiple electronic systems in an automobile, thereby resulting in a space savings in the automobile and realizing cost savings, while maintaining acoustic integrity of the systems. The assembly is made of reasonably priced components, is easy to assemble, and permits for repair or replacement of the components thereof, or of the entire assembly.

In one embodiment, the automotive microphone assembly of the present invention comprises a first microphone, a second microphone, and a connection means for electrically connecting the first and second microphones to a first automotive system and a second automotive system, respectively. Each of the first and second automotive systems comprises one of the group consisting of a telephony system, a speech recognition, system, a speech recording system, an intercom system, a noise control system, a noise compensation system, or a noise monitoring system. If one of the first or second microphones comprises a directional microphone, the corresponding automotive system comprises one of the group consisting of a telephony system, a speech recognition system, a speech recording system, or an intercom system. If one of the first or second microphones comprises an omnidirectional microphone, the corresponding automotive system comprises one of the group consisting of a noise control system, a noise compensation system, or a noise monitoring system.

In another embodiment of the assembly of the present invention, the assembly includes a first microphone having first and second leads, a second microphone having first and second leads, and a connection means. The connection means includes a first input for electrical connection to the leads of the first microphone, a second input for connection to the leads of the second microphone, a first output electrically connected to the first input and for electrical connection to a first automotive system, and a second output electrically connected to the second input and for electrical connection to a second automotive system.

Electrical connections may be made by hardwiring, printed circuit board(s), connector(s), interconnect(s), cable(s), or any combination thereof. Disposed between the first input and first output and/or the second input and second output may be circuitry such as preamplification circuitry, bias circuitry, microphone filtering and/or processing circuitry (such as analog filtering, analog-to-digital conversion, signal-to-noise-ratio enhancement means, digital filtering, or digital processing), and/or the circuitry required for each of the first and second automotive systems.

In another embodiment, the assembly of the present invention includes microphone boot for receipt of a first microphone and a second microphone, a printed circuit board, an interconnect, and a housing for the microphone boot and the printed circuit board. The printed circuit board provides for electrical connection between the first and second microphones and the interconnect. The interconnect provides, generally, for electrical connection to external electronics. In one embodiment, the interconnect provides for electrical connection to the first and second automotive systems. In another embodiment, the printed circuit board provides for electrical connection of the first and second automotive systems (if such electronic resides on the printed circuit board) to other external electronics.

The housing comprises, in one embodiment, a top housing portion for placement over the top of the microphone boot and surrounding the sides of the microphone boot, and a bottom housing portion for placement of the printed circuit board, interconnection, and top housing therein. Alternately, the bottom housing portion could be formed for placement outside the side surfaces of the top housing.

The assembly of the present invention may also comprise an acoustic cloth for placement over the top of the microphone boot between the microphone boot and the top housing portion. Such an acoustic cloth serves to protect the first and second microphones from dust and other foreign matter, and provides some wind noise mitigation. The assembly may also include a gasket for placement over the top of the top housing portion. Such a gasket protect and/or separates the housing from any adjacent or proximate devices in the automobile.

The housing comprises at least two apertures on the top thereof to serve as waveguide openings for the waveguides of the first and second microphones. The housing also comprises at least one other aperture to allow the interconnect to connect to external electronics.

### DETAILED DESCRIPTION OF THE INVENTION

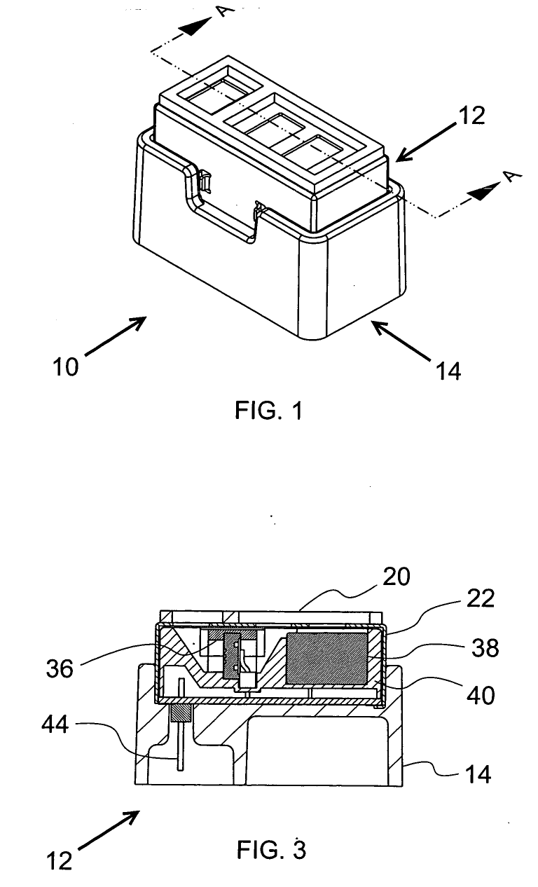

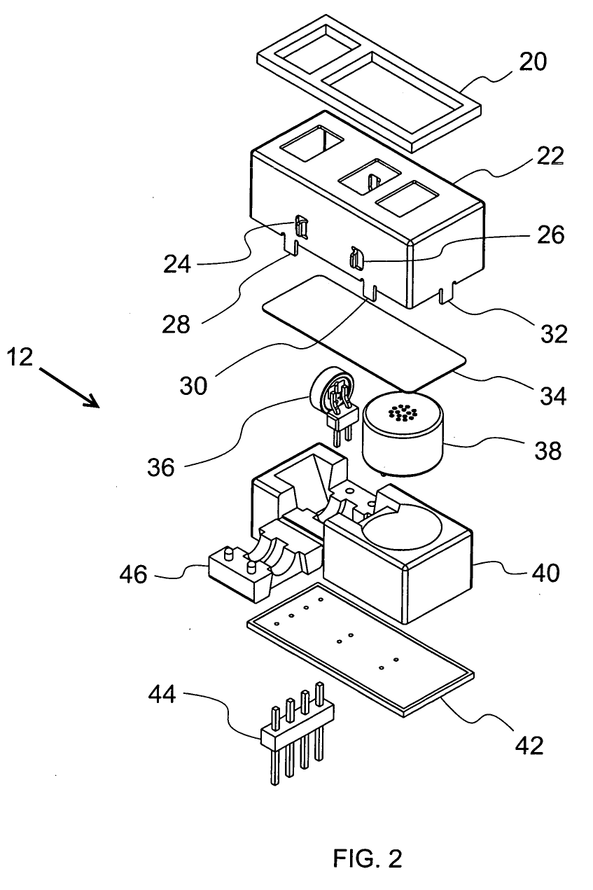

The present invention comprises an automotive microphone assembly. Referring now to FIG. 1, there is shown a perspective view of one embodiment of an automotive microphone assembly of the present invention. As will be explained in greater detail herein, the microphone assembly of FIG. 1 provides outputs in support of multiple outputs for different systems. In the embodiment of FIG. 1, microphone assembly 10 comprises top portion 12 and bottom portion 14. Top portion 12 is shown in greater detail in FIG. 2, and a cross-sectional view of microphone assembly 10 along line A-A is shown in FIG. 3.

FIG. 2 shows a perspective view of the embodiment of FIG. 1 with the components of the top portion of the automotive microphone assembly separated to illustrate assembly of the components thereof. According to this embodiment, top portion 12 of microphone assembly 10 comprises gasket 20, housing 22, acoustic cloth 34, first microphone 36, second microphone 38, microphone boot 40, printed circuit board 42, and header pin assembly 44. In this embodiment, first microphone 36 comprises a directional (cardioid) microphone, and second microphone 38 comprises an omnidirectional microphone. More specifically, first microphone 36 comprises a unidirectional, cardioid type directional microphone wherein its polar directivity response is advantageously modified toward a hyper-cardioid or super cardioid polar directivity response, thereby improving the signal-to-acoustical noise ratio of microphone assembly 10, and, hence assembly sound quality.

Each of first microphone 36 and second microphone 38 comprise a waveguide opening for receipt of acoustic signals to the first and second microphones 36 and 38, respectively. The waveguide opening of first microphone 36 resides on the side surface of first microphone 36 not shown in FIG. 2, and the waveguide opening of second microphone 38 resides on the top surface of second microphone 38. In this embodiment, first and second microphones 36 and 38 are oriented with their cylindrical axes of symmetry perpendicular to each other. Specifically, the cylindrical axis of symmetry of first microphone 36 is parallel to the top surface of microphone boot 40, and the cylindrical axis of symmetry of second microphone 38 is perpendicular to the top surface of microphone boot 40.

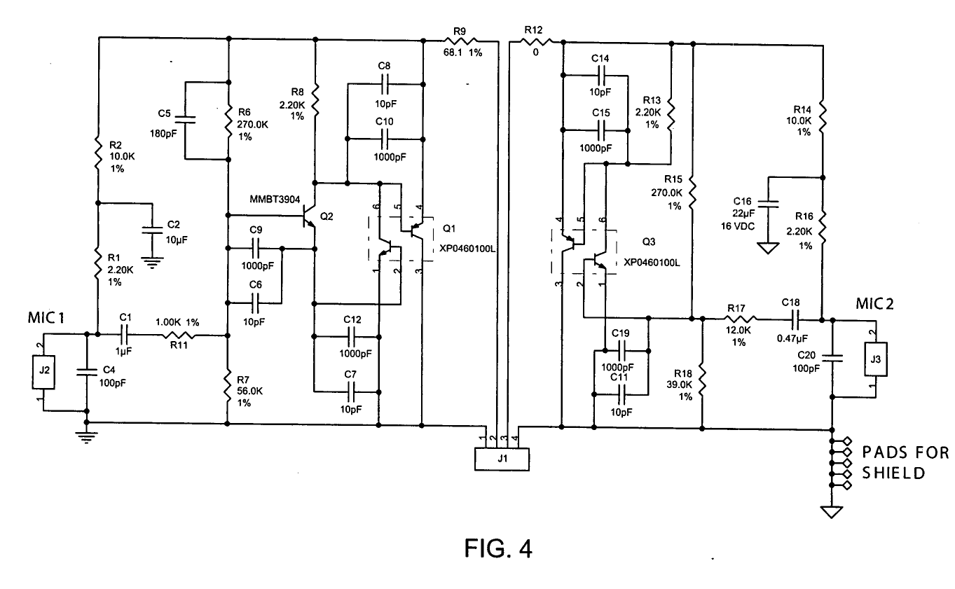

According to the present invention, printed circuit board 42 provides: (1) a pre-amplified directional microphone signal that is used for voice pickup by a hands free telephony system, by an automatic speech recognition system, by a speech recording system, and/or by an intercom system; and (2) a pre-amplified omnidirectional microphone signal as an input to an active noise control system, a noise compensation system, and/or a noise monitoring system. An example of a schematic for printed circuit board 42 is illustrated in FIG. 4. Header pin assembly 44 is an interconnect that provides electrical connection between printed circuit board 42 and these other systems.

Microphone boot 40, acoustic cloth 34, housing 22, and gasket 20 are provided to hold first microphone 36 and second microphone 38 in electrical contact with printed circuit board 42 and for installation of microphone assembly 10 into an automobile. Thus, the materials of microphone boot 40, acoustic cloth 34, housing 22, and gasket 20 are of the type used in prior art microphone assemblies holding only a single microphone to be placed in an automotive environment. For example, microphone boot 40 and housing 22 are comprised of a non-conductive material, such as plastic or elastomeric material such as rubber, and assists in providing an acoustical seal about first microphone 36 and second microphone 38. Similarly, bottom portion 14 (see FIG. 1) is also comprised of non-conductive material, such as plastic. Acoustic cloth 34 may be comprised of organic or synthetic textile or open cell foam, for example, and gasket 20 may be comprised of elastomeric thermoset or thermoplastic, or closed or open cell foam, for example. Acoustic cloth 34 is used to protect first and second microphones 36 and 38 from dust and other foreign matter, as well as providing some wind noise mitigation means, and gasket 20 is used to protect and/or to separate housing 22 from any adjacent or proximate other devices in an automobile. Assembly 10 may installed in various locations in an automobile, including but not limited to the overhead console, overhead liner, rearview mirror, or a pillar when one of the automotive systems supported by assembly 10 requires detection by a microphone located in the interior of the automobile, or within the engine compartment if neither of the automotive systems supported by assembly 10 requires detection by a microphone located in the interior of the automobile.

In the embodiment of FIG. 2, second microphone 38 is inserted into a recess in microphone boot 40. First microphone 36 is also inserted into a recess in microphone boot 40, and hinged portion 46 of microphone boot 40 is rotated from the position shown in FIG. 2 and secured into place to hold first microphone 36 in place (see FIG. 3). Microphone boot 40 rests on printed circuit board 42. Acoustic cloth 34 is placed over the top of microphone boot 40. Housing 22 is sized to receive acoustic cloth 34 and microphone boot 40 in the interior thereof. Gasket 20 is adhered to the top of housing 22.

Referring now to FIG. 3, there is shown a cross-sectional view of the embodiment of the automotive microphone assembly of FIG. 1. The cross-sectional view of FIG. 3 is created along line A-A of FIG. 1. As shown in the combination of FIG. 1, FIG. 2, and FIG. 3, top portion 12 of microphone assembly 10 is connected to bottom portion 14 of microphone 10 by tabs 28, 30, and 32 extending from the bottom of housing 22 and into recesses in bottom portion 14, and side tabs 24 and 26 extending from the side of housing 22 and biasing housing 22 in place against the edge of bottom portion 14. It will be appreciated by those of skill in the art that an alternate embodiment may have bottom portion 14 residing within the interior of top portion 12, or that top portion 12 and bottom potion 14 may be connected to each other by other mechanisms well-known in the art.

Also, as seen in the combination of FIG. 2 and FIG. 3, electrical leads from first microphone 36 and second microphone 38 are permitted to extend through microphone boot 40 by the plurality of apertures extending through microphone boot 40. The presence of apertures in the bottom of microphone boot 40 allows the fist and second leads of first microphone 36 and second microphone 38 to contact pads, or other connectors, on printed circuit board 42. In this manner, first microphone 36 and second microphone 38 are electrically connected to printed circuit board 42 and to the circuitry residing thereon.

In addition, top portion 12 of assembly 10 contains apertures on the top thereof that serve as waveguides for proper transmission to first and second microphones 36 and 38, and, more specifically, waveguides for proper transmission to the waveguide openings of first and second microphones 36 and 38. In the embodiment of FIG. 1, FIG. 2, and FIG. 3, when hinged portion 46 is positioned to hold first microphone 36 is place in microphone boot 40, apertures exist in microphone boot 40 to the left and right of hinged portion 46, with those apertures aligned with the two left most apertures of housing 22. These two left most apertures of microphone boot 40 are spaced, in this embodiment, at a distance greater than two times the cylindrical height (measured along the cylindrical axis) of first microphone 36. It can be seen in FIG. 1, FIG. 2, and FIG. 3 that the combination of the two left most apertures on either side of hinged portion 46 on the top of microphone boot 40, the two left most apertures on the top of housing 22 and the left most opening in gasket 20 serve as a waveguide for the waveguide opening of first microphone 36, and the combination of the right most aperture on the top of microphone boot 40, the right most aperture on the top of housing 22, and the right most opening in gasket 20 serve as a waveguide for the waveguide opening of second microphone 38.

It will be appreciated by those of skill in the art that the plurality of apertures through which the leads of first microphone 36 and second microphone 38 extend may comprise two apertures—one for the first and second leads of first microphone 36 and one for first and second leads of second microphone 38. There may also be one aperture for each such lead, or separate apertures for the leads of one of the microphones and a single aperture for the leads of the other microphone. There may also be only a single aperture through which both first microphone 36 and second microphone 38 extend and through which their respective leads are connected.

Referring now to FIG. 4, there is shown a schematic diagram of one embodiment of the printed circuit board of the automotive microphone assembly of the present invention. Circuitry shown in FIG. 4 consists of two independent microphone preamplifiers used in this embodiment. As shown in FIG. 4, in this embodiment, the microphone amplifiers are electrically isolated from each other, but share a common printed circuit board. One preamplifier is used with directional microphone referred to in the schematic of FIG. 4 as MIC1, and is connected to MIC1 at J2. MIC1 corresponds to first microphone 36 in the drawings of FIG. 1, FIG. 2, and FIG. 3. The other preamplifier is used with omnidirectional microphone referred to in the schematic of FIG. 4 as MIC2, and is connected to MIC2 at J3. MIC2 corresponds to second microphone 38 in the drawings of FIG. 1, FIG. 2, and FIG. 3.

For directional microphone MIC1 and associated circuitry, transistors Q1A and Q2 form a high gain NPN Darlington pair. Transistor Q1B is used to form a complementary Darlington PNP/NPN configuration with first dual NPN Darlington pair. Standard Darlington pairs of NPN or PNP transistors and Complementary Darlington Pairs of NPN and PNP transistors are well-known. The three transistors Q1A, Q1B and Q2 configured as a Darlington/complementary Darlington configuration and form a very high open loop gain inverting amplifier. Typical open loop gain is on the order of 140 dB.

Feedback network C5 and R6 form a feedback impedance from output to input of the preamplifier. C1 and R11 form an input impedance of the amplifier. The impedance ratio of C5 and R6 divided by impedance of C1 and R11 set the closed loop gain of the microphone preamplifier for MIC1. In the embodiment of FIG. 4, the closed loop gain is 49 dB and about 43 dB when loaded with impedance of bias resistor R1 and output impedance of microphone MIC1.

Resistors R2 and capacitor C2 provide a stable DC bias voltage to operate MIC1. Resistor R1 is used to bias MIC1 from this bias voltage. The preamplifier is self biased from an external voltage and bias resistor, for example, 12 volts and 2K ohms. The ratio of resistor R6 to R7, along with the forward base emitter voltage drop of Q2 and Q1A, set the DC operating point of the microphone preamplifier for MIC1 when powered from external bias voltage of 12 volts through a 2K ohm resistor. A typical DC bias point is 6 volts.

Resistor R8 sets the bias current ratio of transistors Q1A and Q1B. Bias collector current of transistor Q1A is set at the base emitter forward voltage drop of transistor Q1B divided by resistance R8. Capacitors C6, C9, C4, C12, and C7 are provided to reduce susceptibility to pickup and demodulation of radio frequency interference. Resistor R9 is provided to prevent damage should the preamplifier for MIC1 be directly connected to 12 volts without a bias resistor. R9 also helps provide immunity to radio frequency interference. Output of the microphone preamplifier for MIC1 is typically −5 dBV/Pa.

As illustrated in FIG. 4, the preamplifier circuitry used for omnidirectional microphone MIC2 is similar in nature to the preamplifier circuitry for directional microphone MIC1, although the open loop gain needed to meet final gain and distortion requirements of total system for MIC2 is not as high as for MIC1. Transistors Q3A and Q3B form a complementary Darlington pair with open loop gain of typically 100 dB. Feedback resistor R15, divided by the input impedance formed by R17 and C18 set the closed loop preamplifier gain. In the embodiment of FIG. 4, the closed loop gain is 27 dB. Resistor R14 and capacitor C16 provide a stable DC bias voltage to operate MIC2. Resistor R16 is used to bias MIC2 from this bias voltage. The preamplifier is self biased from an external voltage and bias resistor, for example 9 volts and 1K ohms. The ratio of resistors R15 and R18, along with the forward base emitter voltage drop of Q3A, set the DC operating point of the microphone preamplifier for MIC2 when powered from external bias voltage of 12 volts through a 2K ohm resistor. A typical DC Bias point is about 4.5 volts.

Resistor R13 sets the bias current ratio of transistors Q3A and Q3B. Bias collector current of transistor Q3A is set at the base emitter forward voltage drop of transistor Q3B divided by resistance R13. Capacitors C14, C15, C11, C19, and C20 are provided to reduce susceptibility to pickup and demodulation of radio frequency interference. Resistor R12 is set to 0 ohms for use with a protected 9V supply. Should the amplifier for MIC2 need to be powered from 12 V vehicle battery power, a small resistor should be used to provide protection from damage should the preamplifier be directly connected to 12 volts without a bias resistor. Output of the for omnidirectional microphone MIC2 is typically −13 dBV/Pa.

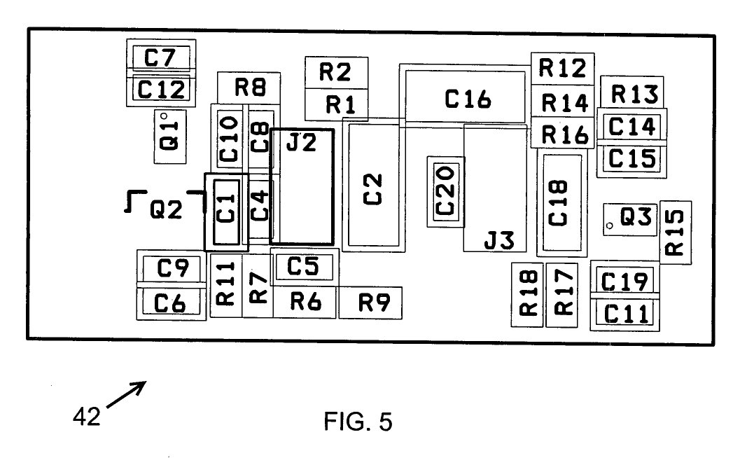

FIG. 5 shows an assembly diagram of the embodiment of the printed circuit board of the automotive microphone assembly of FIG. 4. FIG. 5 simply illustrates the placement of the components on a printed circuit board according to the schematic of FIG. 4. Listed on Table 1 are one embodiment of the components of printed circuit board 42:

TABLE 1

| REFERENCE | | SUPPLIER PART | |
|---|---|---|---|
| DESIGNATOR | DESCRIPTION | NUMBER | SUPPLIER |
| C1 | Cap Cer 1 μF 10% 16 V X5R 0603 SM | ECJ1VB1C105K | Panasonic |
| C2 | Cap Cer 10 μF 20% 16 V X5R 1206 SM | ECJ3YB1C106M | Panasonic |
| C4 C20 | Cap Cer 100 pF 10% 50 V X7R 0402 SM | ECJ0EB1H101K | Panasonic |
| C5 | Cap Cer 180 pF 5% 50 V NPO 0402 SM | ECJ0EC1H181J | Panasonic |
| C6 C7 C8 C11 C14 | Cap Cer 10 pF ±0.5 pF 50 V NPO 0402 SM | ECJ0EC1H100D | Panasonic |
| C9 C10 C12 C15 C19 | Cap Cer 1000 pF 10% 50 V X7R 0402 SM | ECJ0EB1H102K | Panasonic |
| C16 | Cap Cer 22 μF 20% 16 V X5R 1206 SM | ECJ3YB1C226M | Panasonic |
| C18 | Cap Cer 0.47 μF 10% 16 V X7R 0805 SM | ECJ2YB1C474K | Panasonic |
| J1 | Connection for header | | |
| J2 | Connection for Microphone1 | | |
| J3 | Connection for Microphone2 | | |
| Q1 Q3 | Trans NPN/PNP 60 V 100 mA 150 mW SC88 SM | XP0460100L | Panasonic |
| Q2 | Trans NPN 40 V 200 mA 350 mW SOT23 SM | MMBT3904 | Fairchild |
| R1 R8 R13 R16 | Res 2.20K 1% 1/16 W 0402 SM | 9C04021A2201FLHF3 | Yageo |
| R2 R14 | Res 10.0K 1% 1/16 W 100 ppm 0402 SM | ERJ2RKF1002X | Panasonic |
| R6 R15 | Res 270.0K 1% 1/16 W 0402 SM | 9C04021A2703FLHF3 | Yageo |
| R7 | Res 56.0K 1% 1/16 W 0402 SM | 9C04021A5602FLHF3 | Yageo |
| R9 | Res 68.1 1% 1/16 W 100 ppm 0402 SM | ERJ2RKF68R1X | Panasonic |
| R11 | Res 1.00K 1% 1/16 W 100 ppm 0402 SM | ERJ2RKF1001X | Panasonic |
| R12 | Res 0 1/16 W Jumper 0402 SM | ERJ2GE0R00X | Panasonic |
| R17 | Res 12.0K 1% 1/16 W 0402 SM | 9C04021A1202FLHF3 | Yageo |
| R18 | Res 39.0K 1% 1/16 W 0402 SM | 9C04021A3902FLHF3 | Yageo |
| M1677-PCB-A | PCB, double-sided, FR4, 0.031″ (0.79 mm) thick | | |

It will be appreciated by those of skill in the art that the present invention provides a compact assembly for microphones used to support multiple systems. In the particular instance illustrated in FIG. 1, FIG. 2, FIG. 3, FIG. 4, and FIG. 5, the directional microphone is used in support of the telephony system, speech recognition system, speech recording system, and/or intercom system, and the omnidirectional microphone is used in support of a noise control system, noise compensation system or noise monitoring system. By the use of the present invention, the microphones and related electronics required to provide pre-amplified signals from the microphones are provided in a single housing. Thus, the assembly saves space in the automobile, and provides for cost savings by use of a single housing and electronics for two microphone systems.

It will also be appreciated by those of skill in the art that the preamplifier circuits of FIG. 4 and FIG. 5 are exemplary and designed to address specific requirements. Other electrical preamplification circuits designed to address the same or other requirements are contemplated to be within the scope of the present invention.

It will be further appreciated that the microphone assembly of the present invention is comprised of reasonably priced components. It will be still further appreciated that the microphone assembly is easy to assemble. The components of the assembly are made to “fit” with respect to connecting components. It will be yet further appreciated that the microphone assembly of the present invention permits for repair or replacement of the entire assembly, or of components thereof. While the components may be repaired or replaced, it may be most cost effective to simply repair or replace the entire assembly.

It will also be appreciated by those of skill in the art that, while only two microphones were illustrated herein, the present invention is contemplated to be used to support more than two microphones and subsystems requiring such microphones. For example, a first directional microphone for connection with a telephony subsystem, a second directional microphone for connection with a voice recognition subsystem, and a first omnidirectional microphone for a noise monitoring subsystem can be held in a single microphone boot and supported by a single printed circuit board according to the principles taught by the embodiment illustrated herein.

It will also be appreciated by those of skill in the art that the printed circuit board present herein comprises a connection means between the first and second microphones and the first and second automotive systems, respectively. Other connection means are contemplated to be within the scope of the present invention, including but not limited to hardwired circuits, connectors, interconnects, cables, or any combination of wires, connectors, interconnects, cables, and printed circuit boards. Further, the connection means need not comprise the preamplifier circuits discussed in the embodiment of FIGS. 1 through 5. Instead, the connection means may comprise simple circuitry for connection of the leads of the microphones to circuitry apart from the microphone assembly for the first and second automotive systems, bias circuitry for each microphone, microphone filtering and/or processing circuitry (such as analog filtering, analog-to-digital conversion, signal-to-noise-ratio enhancement means, digital filtering, digital processing, etc.), and/or the circuitry required for each of the first and second automotive systems. As used in the claims, the term “connection means” encompasses all of these alternatives and all equivalents thereof.

It will be still further appreciated that variations of the combinations of microphones, connection means, and housings may achieve the result of an automotive vehicle module connecting a plurality of microphones with a plurality of automotive systems. In some instances, a housing may not be necessary, although for ease of assembly and to protect the module from the elements, a housing may be desired. While the embodiment of FIGS. 1 through 5 shows a combination of a microphone boot 40, top portion 12, and bottom portion 14 for housing the microphones and the printed circuit board (connection means), other alternative housings are contemplated to be within the scope of the invention. As used in the claims, the term “housing” refers to a combination of a boot and top and bottom portions, top and bottom portions without a microphone boot, top and bottom portions of variant shapes and sizes from that illustrated herein, and encapsulation of the microphones and connection means in plastic or composite material. Of course, with such alternatives, apertures that serve as waveguides must be appropriately formed for proper transmission of acoustic energy to each of the microphones and, similarly, apertures must be appropriately formed for the output(s) of the connection means. With these alternatives in mind, some variants on the automotive microphone assembly of the present invention include, but are not limited to, combinations of the microphones and: (a) a hardwired cable plus a housing; (b) one or more microphone boots, a cable, and a housing; (c) a printed circuit board and an interconnect; (d) a printed circuit board, an interconnect, and a housing; (e) one or more microphone boots, a printed circuit board, and an interconnect; and (f) one or more microphone boots, a printed circuit board, an interconnect, and a housing.

It will be yet further appreciated that the automotive microphone assembly of the present invention is compact. The microphones of the present invention are co-located—in close proximity to each other. In one embodiment, the nearest points between the housings of the microphones are no further apart than 2 centimeters. Thus, the automotive microphone assembly does not consume a significant amount of space in the automobile, yet the acoustic integrity of the automotive system served by the microphone is maintained.

As used herein and in the claims, the term “automobile” and “automotive” includes any motorized vehicle that may include two or more of the telephony, speech recognition, speech recording, intercom, noise control, noise compensation, or noise monitoring systems. Thus, the terms “automobile” and “automotive” includes, but is not limited to, cars, trucks, sport utility vehicles, motorcycles, tractors and other farm equipment, cranes, front loaders and other construction equipment, and riding lawn mowers.

In view of the many possible embodiments to which the principles of this invention may be applied, it should be recognized that the detailed embodiments are illustrative only and should not be taken as limiting the scope of the invention. Rather, the invention comprises all such embodiments as may come within the scope and spirit of the invention and equivalents thereto.

I claim:

1. An automotive microphone assembly, comprising:
a first microphone;
a second microphone; and
a connection means for electrical connection to the first microphone and to the second microphone, for electrical connection of the first microphone to a first system of an automobile consisting of one of the group of a telephony system, a speech recognition system, a speech recording system, an intercom system, a noise control system, a noise compensation system, or a noise monitoring system, and for electrical connection of the second microphone to a second system of an automobile consisting of another one of the group of a telephony system, a speech recognition system, a speech recording system, an intercom system, a noise control system, a noise compensation system, or a noise monitoring system.

2. The assembly of claim 1, wherein the first microphone comprises a directional microphone, and the first system consists of one of the group of a telephony system, a speech recognition system, a speech recording system, or an intercom system.

3. The assembly of claim 1, wherein the second microphone comprises an omnidirectional microphone, and the second system consists of one of the group of a noise control system, a noise compensation system, or a noise monitoring system.

4. The assembly of claim 1, wherein the first microphone comprises a first lead and a second lead, and wherein the second microphone comprises a first lead and a second lead, the assembly further comprising a microphone boot for receipt of the first microphone and the second microphone, the microphone boot having a plurality of apertures therethrough to permit the first and second leads of the first microphone and the first and second leads of the second microphone to contact the connection means when the connection means is placed beneath the microphone boot.

5. The assembly of claim 4, further comprising:
an acoustic cloth for placement over the tops of each of the first microphone and the second microphone when the first and second microphones are placed in the microphone boot;
a housing for placement over the acoustic cloth and around the sides of the microphone boot;
an interconnect for electrical connection to the connection means and for connection to the first and second system; and
a bottom portion for holding the interconnect against the connection means, and for engagement with the housing.

6. The assembly of claim 5, further comprising:
a gasket for placement on top of the housing.

7. The assembly of claim 1, wherein the connection means further comprises a first preamplifier circuit between the first microphone and the first system, and wherein the first preamplifier circuit comprises:
an input for connection to the first microphone;
an output for connection to the first system;
an open loop gain inverting amplifier operatively connected to the input; and
a feedback network operatively connected to the input and to the output to form a feedback impedance from the output to the input.

8. The assembly of claim 1, wherein the connection means further comprises a second preamplifier circuit between the second microphone and the second system, wherein the second preamplifier circuit comprises:
an input for connection to the second microphone;
an output for connection to the second system;
an open loop gain inverting amplifier operatively connected to the input; and
a feedback network operatively connected to the input and to the output to form a feedback impedance from the output to the input.

9. The assembly of claim 1, wherein the connection means further comprises a bias circuit between the first microphone and the first system.

10. The assembly of claim 1, wherein the connection means further comprises a bias circuit between the second microphone and the second system.

11. The assembly of claim 1, wherein the connection means further comprises a microphone processing circuit between the first microphone and the first system.

12. The assembly of claim 1, wherein the connection means further comprises a microphone processing circuit between the second microphone and the second system.

13. The assembly of claim 1, wherein the connection means comprises a printed circuit board.

14. The assembly of claim 1, wherein the connection means comprises wires.

15. The assembly of claim 1, wherein the connection means comprises a cable.

16. The assembly of claim 1, wherein the connection means comprises an interconnect.

17. The assembly of claim 1, wherein the connection means comprises a connector.

18. An automotive microphone assembly, comprising:
a first microphone comprising a first lead, a second lead, and a diaphragm;
a second microphone comprising a first lead, a second lead, and a diaphragm;
a connection means for electrical connection having a first input, a second input, a first output, and a second output, the first input for electrical connection to the first and second leads of the first microphone, the second input for electrical connection to the first and second leads of the second microphone, the first output for electrical connection to a first system of an automobile, and the second output for electrical connection to a second system of an automobile, the first system consisting of one of the group of a telephony system, a speech recognition system, a speech recording system, an intercom system, a noise control system, a noise compensation system, or a noise monitoring system, and the second system consisting of another one of the group of a telephony system, a speech recognition system, a speech recording system, an intercom system, a noise control system, a noise compensation system, or a noise monitoring system;
an interconnect for connection to the first and second outputs of the connection means; and
a housing for housing the first microphone, the second microphone, and the connection means, and having apertures therethrough for exposure of the diaphragms of the first and second microphones and for exposure of the interconnect.

19. The assembly of claim 18, wherein each of the first and second microphones comprises a waveguide opening, the assembly further comprising:
an acoustic cloth for placement over the waveguide openings of the first and second microphones.

20. The assembly of claim 18, further comprising:
a gasket for placement over the top of the housing.

21. The assembly of claim 18, wherein the first microphone comprises a directional microphone, and the first system consists of one of the group of a telephony system, a speech recognition system, a speech recording system, or an intercom system.

22. The assembly of claim 18, wherein the second microphone comprises an omnidirectional microphone, and the second system consists of one of the group of a noise control system, a noise compensation system, or a noise monitoring system.

23. The assembly of claim 18, further comprising a first preamplifier circuit between the first input and the first output.

24. The assembly of claim 18, further comprising a second preamplifier circuit between the second input and the second output.

25. An automotive microphone assembly, comprising:
a first microphone having a first lead and a second lead;
a second microphone having a first lead and a second lead;
a microphone boot for receipt of the first microphone and the second microphone and having a plurality of apertures through the bottom thereof to allow the first and second leads of the first and second microphones to extend therethrough;
a printed circuit board for electrical connection having a first input, a second input, a first output, and a second output, the first input for electrical connection to the first and second leads of the first microphone, the second input for electrical connection to the first and second leads of the second microphone, the first output for electrical connection to a first system of an automobile, and the second output for electrical connection to a second system of an automobile, the first system consisting of one of the group of a telephony system, a speech recognition system, a speech recording system, an intercom system, a noise control system, a noise compensation system, or a noise monitoring system, and the second system consisting of another one of the group of a telephony system, a speech recognition system, a speech recording system, an intercom system, a noise control system, a noise compensation system, or a noise monitoring system;
an interconnect for connection to the first and second outputs of the printed circuit board;
a top housing for placement over the top of the microphone boot and surrounding the sides of the microphone boot; and
a bottom housing for placement of the printed circuit board, the interconnect, and the top housing therein.

26. The assembly of claim 25, further comprising:
an acoustic cloth for placement over the top of the microphone boot between the microphone boot and the top housing.

27. The assembly of claim 25, further comprising:
a gasket for placement over the top of the top housing.

28. The assembly of claim 25, wherein the first microphone comprises a directional microphone, and the first system consists of one of the group of a telephony system, a speech recognition system, a speech recording system, or an intercom system.

29. The assembly of claim 25, wherein the second microphone comprises an omnidirectional microphone, and the second system consists of one of the group of a noise control system, a noise compensation system, or a noise monitoring system.

30. The assembly of claim 25, further comprising a first preamplifier circuit between the first input and the first output, the first preamplifier circuit comprising:
an open loop gain inverting amplifier operatively connected to the first input; and
a feedback network operatively connected to the first input and to the first output to form a feedback impedance from the first output to the first input.

31. The assembly of claim 25, further comprising a second preamplifier circuit between the second input and the second output, the second preamplifier circuit comprising:
an open loop gain inverting amplifier operatively connected to the second input; and
a feedback network operatively connected to the second input and to the second output to form a feedback impedance from the second output to the second input.
